(19) United States
(12) Patent Application Publication
(10) Pub. No.: US 2012/0027240 A1
(43) Pub. Date: Feb. 2, 2012

(54) MICROPHONE MODULE WITH HELMHOLTZ RESONANCE CHAMBER

(75) Inventor: HWANG-MIAW CHEN, Tu-Cheng (TW)

(73) Assignee: FOXCONN TECHNOLOGY CO., LTD., Tu-Cheng (TW)

(21) Appl. No.: 13/272,175

(22) Filed: Oct. 12, 2011

Related U.S. Application Data
(63) Continuation-in-part of application No. 12/758,805, filed on Apr. 13, 2010, now abandoned.

(30) Foreign Application Priority Data
Dec. 30, 2009 (CN) 200910312666.X

(51) Int. Cl. H04R 11/04

(52) U.S. Cl. 381/360

(57) ABSTRACT

An exemplary microphone module includes a shell, a circuit board located in the shell, and a microphone located in the shell and electrically connecting the circuit board. The shell includes a bottom cover and a faceplate on the bottom cover. The faceplate defines a sound hole therein. A washer is provided between the microphone and the faceplate. The washer defines a sound chamber therein. The sound chamber has a diameter exceeding that of the sound hole of the faceplate. The sound chamber communicates with the sound hole, and the sound chamber and the sound hole cooperatively form a Helmholtz resonance chamber outside of the microphone.

### CROSS-REFERENCE TO RELATED APPLICATIONS

The present application is a continuation-in-part (CIP) application of patent application Ser. No. 12/758,805 entitled “MICROPHONE MODULE WITH HELMHOLTZ RESONANCE CHAMBER” and filed on Apr. 13, 2010, whose disclosure is incorporated herein by reference in its entirety.

### BACKGROUND

1. Technical Field

The disclosure generally relates to microphones and, particularly, to a microphone module with Helmholtz resonance chambers.

2. Description of Related Art

With the continuing development of audio and sound technology, microphones have been widely used in electronic devices such as headsets, mobile phones, computers and other devices providing audio capabilities.

A typical microphone defines a resonance chamber therein. The size of the resonance chamber promotes a corresponding mass of air with commensurate quality of low frequency sound transmitted. If the microphone is reduced in size, the size of the resonance chamber of the microphone and the maximum power the microphone can handle are accordingly reduced, resulting in both a reduction in loudness as well as a poorer overall quality of sound. On the other hand, increasing the size of the microphone to increase the size of the resonance chamber is not feasible in many portable device applications.

What is needed, therefore, is a microphone module which can address the limitations described.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the various views.

FIG. 1 is an assembled, isometric view of a microphone module in accordance with an embodiment of the disclosure.

FIG. 2 is an exploded, isometric view of the microphone module of FIG. 1.

FIG. 3 is similar to FIG. 2, but viewed from another aspect.

FIG. 4 is a cross section of the microphone module of FIG. 1, taken along line IV-IV thereof.

### DETAILED DESCRIPTION

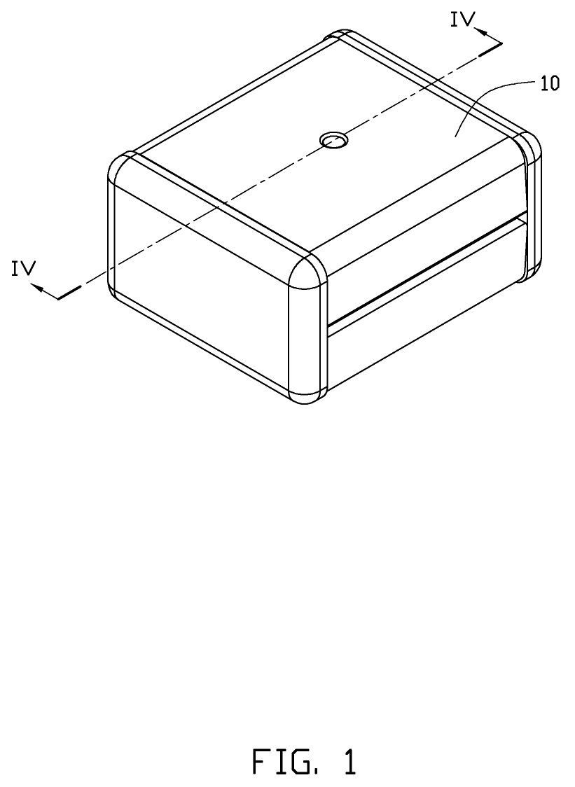

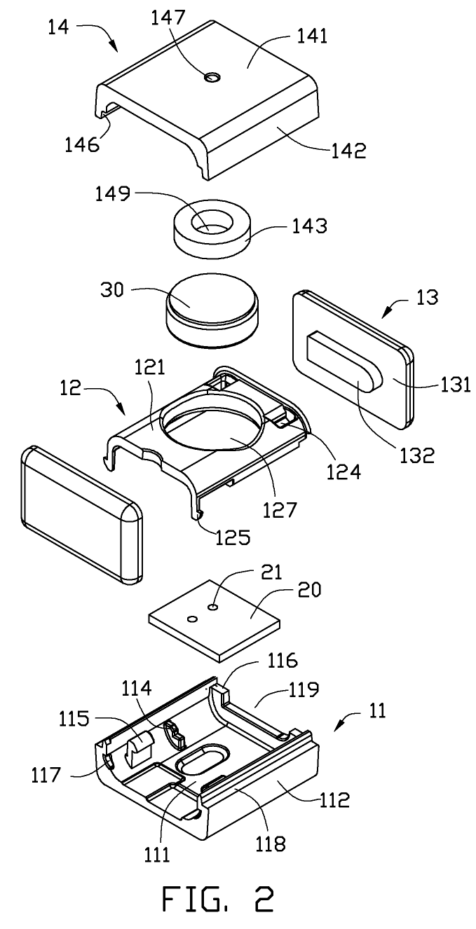

Referring to FIGS. 1 and 2, a microphone module in accordance with one embodiment of the present disclosure is shown. The microphone module is configured for use in electronic devices such as headsets, mobile phones, computers, and others. The microphone module includes a shell 10, a circuit board 20 located in the shell 10, and a microphone 30 located on the circuit board 20.

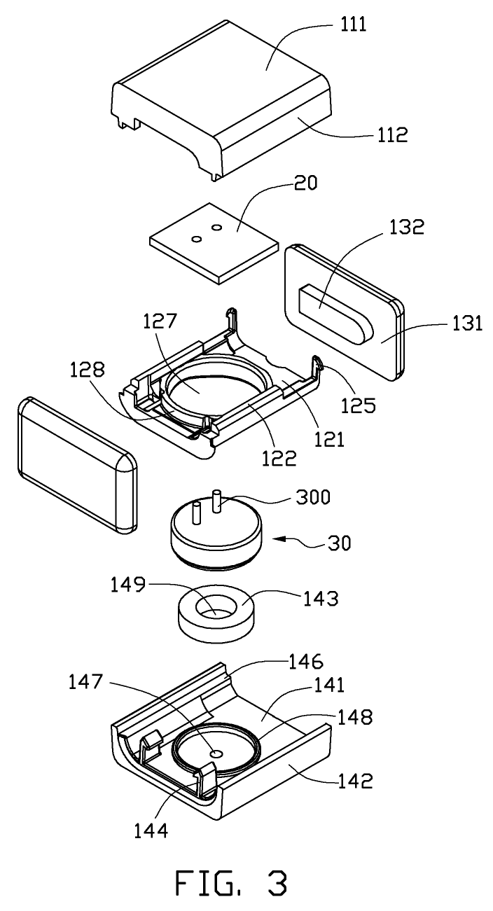

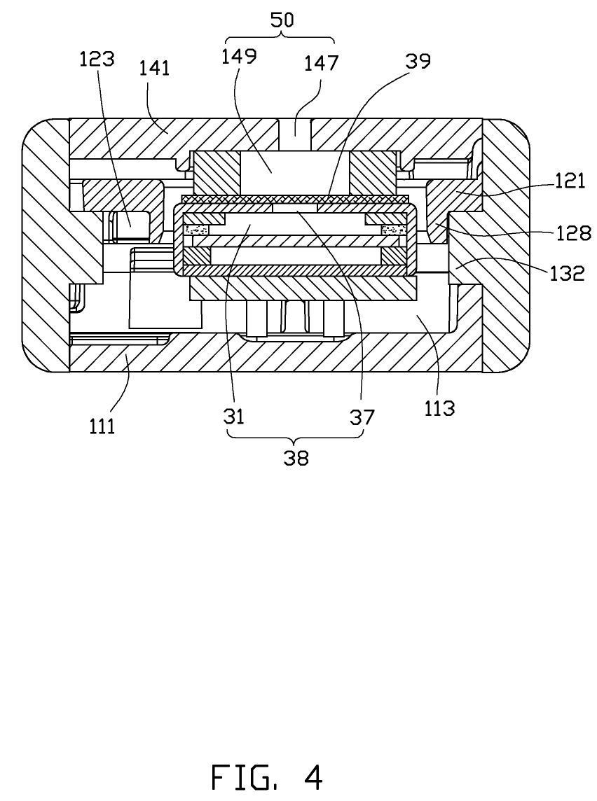

Referring to FIGS. 3 and 4, the shell 10 includes a bottom cover 11, a top cover 12 engaging the bottom cover 11, a pair of baffle plates 13 respectively disposed at opposite ends of the bottom and top covers 11, 12, and a faceplate 14 located on the top cover 12.

The bottom cover 11 is semi-enclosed, and includes a bottom wall 111, two sidewalls 112 extending upwardly from two opposite sides of the bottom wall 111, respectively, and an engaging wall 116 extending upwardly from an end of the bottom wall 111. The bottom wall 111 and the sidewalls 112 cooperatively define a receiving chamber 113 therebetween (see FIG. 4). The bottom wall 111 is substantially rectangular. A pair of supporting ribs 114 and a pair of elastically-deformable buckles 115 extend upwardly from the two sidewalls 112, respectively. The supporting ribs 114 can support the circuit board 20 thereon, and the buckles 115 press the circuit board 20 downwardly towards the supporting ribs 114, thereby fixing the circuit board 20 within the bottom cover 11. Each of the sidewalls 112 defines a mounting groove 117 in an inner surface thereof. The mounting grooves 117 communicate with the receiving chamber 113. Each of the sidewalls 112 forms a step 118 at a top end thereof. An outer side of the step 118 is lower than an inner side of the step 118. The engaging wall 116 interconnects the two sidewalls 112. The engaging wall 116 has a height smaller than that of the sidewall 112. The engaging wall 116 defines a depression 119 in a top face thereof for engaging with the baffle plate 13.

The top cover 12 is also semi-enclosed, and includes a top wall 121 and two sidewalls 122 depending downwardly from two opposite sides of the top wall 121, respectively. The top wall 121 and the sidewalls 122 cooperatively define a receiving chamber 123 therebetween (see FIG. 4).

The top wall 121 is substantially rectangular, and defines a rectangular hole 124 at each of two adjacent corners thereof. The top wall 121 further defines a through hole 127 in a central area thereof. The top wall 121 has an annular flange 128 extending perpendicular to an outer edge of the through hole 127 towards the bottom cover 11.

A distance between outer surfaces of the two sidewalls 122 of the top cover 12 is equal to or slightly less than a distance between inner surfaces of the two sidewalls 112 of the bottom cover 11. A mounting hook 125 depends from a bottom end of each sidewall 122 of the top cover 12, and is received in the mounting groove 117 of a corresponding sidewall 112 of the bottom cover 11, thereby locking the top cover 12 with the bottom cover 11.

The baffle plates 13 are made of elastic material, such as rubber. Each of the baffle plates 13 includes a base 131 and a protrusion 132 protruding inwardly from a central area of the base 131. The base 131 is rectangular and joined to lateral sides of the top wall 121 of the top cover 12 and the bottom wall 111 of the bottom cover 11. The protrusion 132 of one baffle plate 13 is received in the depression 119 of the bottom cover 11 and pressed downwardly by a bottom face of the top wall 121 of the top cover 12 and abuts against an outer circumferential face of the flange 128 of the top cover 12. The protrusion 132 of the other baffle plate 13 is pressed downwardly by the bottom face of the top wall 121 of the top cover 12.

The faceplate 14 includes a top plate 141, two side plates 142 extending downwardly and respectively from two opposite sides of the top plate 141 towards the bottom cover 11, and a washer 143 attached to the top plate 141.

The top plate 141 is substantially rectangular, and has an engaging hook 144 depending toward the bottom cover 11 from a bottom face of the top plate 141. The engaging hooks 144 of the top plate 141 are received in the rectangular holes 124 of the top cover 12 so that the faceplate 14 is fixed to the top cover 12.

The top plate 141 defines a sound hole 147 in a center thereof. The sound hole 147 extends perpendicularly through the top plate 141, and is aligned with the through hole 127 of the top cover 12. The sound hole 147 is circular, and has a diameter far less than that of the through hole 127 of the top cover 12. The top plate 141 has an annular flange 148 extending towards the top cover 12. The annular flange 148 is disposed around the sound hole 147.

The washer 143 is hollow and made of elastic material such as sponge, rubber, or another suitable material. The washer 143 is adhered to the top plate 141 in the annular flange 148 and a top face of the microphone 30. In one embodiment, the washer 143 is annular and has a through hole as a sound chamber 149 therein. An outer diameter of the washer 143 is less than the inner diameter of the orienting flange 148. An inner diameter of the washer 143, namely, a diameter of the sound chamber 149, exceeds that of the sound hole 147.

Each of the side plates 142 forms a step 146 at a bottom end thereof. An outer side of the step 146 is lower than an inner side of the step 146. The steps 146 are matched with the steps 118 of the sidewalls 112 of the bottom cover 11 so that the faceplate 14 can be fittingly engaged with the bottom cover 11.

The circuit board 20 is received in the receiving chamber 113 of the bottom cover 11 of the shell 10. The circuit board 20 forms a pair of holes 21 therein.

The microphone 30 is disposed on the top surface of the circuit board 20, and electrically connects to the circuit board 20. In this embodiment, the microphone 30 is an electret condenser microphone (ECM). The microphone 30 is cylindrical with two pins 300 extending downwardly into the two holes 21 of the circuit board 20. The microphone 30 has an outer diameter less than an inner diameter of the through hole 127 of the top cover 12 of the shell 10. The microphone 30 defines an acoustic chamber 31 in an interior thereof, and an acoustic hole 37 in a top end thereof. The acoustic hole 37 communicates the acoustic chamber 31 with an exterior. The acoustic hole 37 and the acoustic chamber 31 cooperatively form a first Helmholtz resonance chamber 38 in the microphone 30. A tuning cloth 39, made of unwoven cloth, is arranged on the acoustic hole 37. A bottom surface of the washer 143 is fixed to the tuning cloth 39. The tuning cloth 39 cooperates with the acoustic hole 37 to improve the sound quality factor and adjust the sound sharpness of the microphone 30.

In the present microphone module, the washer 143 with the sound chamber 149 therein is provided between the microphone 30 and the faceplate 14, and the sound chamber 149 of the washer 143 and the sound hole 147 of the top plate 141 of the faceplate 14 cooperatively form a second Helmholtz resonance chamber 50 outside of the microphone 30. The two Helmholtz resonance chambers 38, 50 work together to improve sound quantity of the microphone module, i.e., widening the frequency bandwidth of the sound generated by the microphone module, and lowering the lowest resonance frequency of the sound generated by the microphone module. On the other hand, an interior space of the microphone module is adequately used without increasing a volume of the microphone module.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A microphone module, comprising:
a shell comprising a bottom cover and a faceplate on the bottom cover, the faceplate defining a sound hole therein;
a circuit board located in the shell;
a microphone located in the shell and electrically connected to the circuit board; and
a washer provided between the microphone and the faceplate of the shell, the washer defining a sound chamber therein, a diameter of the sound chamber exceeding that of the sound hole of the shell, the sound chamber communicating with the sound hole, the sound chamber and the sound hole cooperatively forming a Helmholtz resonance chamber outside of the microphone.

2. The microphone module of claim 1, wherein the microphone defines an acoustic chamber in an interior thereof, and an acoustic hole in a top end thereof, the acoustic hole communicates the acoustic chamber with an exterior, and the acoustic hole and the acoustic chamber cooperatively form a Helmholtz resonance chamber in the microphone.

3. The microphone module of claim 2, wherein a tuning cloth is arranged on the acoustic hole, and a bottom surface of the washer is fixed to the tuning cloth.

4. The microphone module of claim 3, wherein the tuning cloth is located between the two Helmholtz resonance chambers.

5. The microphone module of claim 1, wherein the faceplate comprises a first annular flange extending downwardly, the first annular flange is disposed around the sound hole, the washer is located in the first annular flange, and an outer diameter of the washer is less than an inner diameter of the first annular flange.

6. The microphone module of claim 1, wherein the washer is elastic.

7. The microphone module of claim 1, wherein the shell further comprises a top cover engaging the bottom cover, and the top cover is disposed between the bottom cover and the faceplate.

8. The microphone module of claim 7, wherein the top cover comprises a top wall and a pair of sidewalls extending downwardly from two opposite sides of the top wall, and the top wall defines a through hole to receive the microphone.

9. The microphone module of claim 8, wherein the top cover defines a hole in the top wall adjacent to the through hole, and the faceplate has an engaging hook engaged in the hole of the top cover.

10. The microphone module of claim 8, wherein the top cover comprises a second annular flange extending downwardly from a bottom face of the top plate and around the through hole, and the microphone is surrounded by the second annular flange.

11. The microphone module of claim 10, wherein the bottom cover comprises a bottom wall and a pair of sidewalls extending upwardly from two opposite sides of the bottom wall, a distance between outer surfaces of the two sidewalls of the top cover is not larger than that between inner surfaces of the two sidewalls of the bottom cover.

12. The microphone module of claim 11, wherein each of the sidewalls of the bottom cover defines a mounting groove therein, the top cover have two hooks extending downwardly from the two sidewalls thereof and locked in the mounting grooves of the bottom cover, respectively.

13. The microphone module of claim 11, wherein the bottom cover comprises a supporting rib formed upwardly on one sidewall thereof, and the circuit board is disposed on the supporting rib.

14. The microphone module of claim 13, wherein the bottom cover comprises a buckle formed upwardly on the sidewall thereof, and the circuit board is pressed downwardly by the buckle towards the supporting rib.

15. The microphone module of claim 11, wherein the bottom cover comprises an engaging wall extending upwardly from an end of the bottom wall, and the engaging wall interconnects the two sidewalls of the bottom cover.

16. The microphone module of claim 15, wherein the shell further comprises a pair of baffle plates attached to the faceplate and the bottom cover.

17. The microphone module of claim 16, wherein each of the baffle plates comprises a base and a protrusion extending inwardly from the base, the base being joined with lateral faces of the top wall of the top cover and the bottom wall of the bottom cover.

18. The microphone module of claim 17, wherein the engaging wall defines a depression in a top face thereof, the protrusion of one baffle plate is received in the depression and abuts against the bottom face of the top wall and an outer circumferential face of the flange of the top cover.

19. A microphone module, comprising:
a shell comprising a bottom cover and a faceplate covering the bottom cover, the faceplate defining a sound hole therein;
a washer having a through hole defined therein, the washer being attached to an inner surface of the faceplate with one end of the through hole aligning and communicating with the sound hole;
a circuit board located in the shell;
a microphone located between the washer and the circuit board, and electrically connected to the circuit board, wherein the microphone defines an acoustic chamber in an interior thereof, and an acoustic hole in a top surface thereof away from the circuit board, the acoustic hole communicates the acoustic chamber with an exterior, and the acoustic hole and the acoustic chamber cooperatively form a first Helmholtz resonance chamber; and
a tuning cloth arranged on the top surface of the microphone, the tuning cloth covering both the acoustic hole and another end of the through hole of the washer, wherein the acoustic hole aligns with the another end of the through hole, and a second Helmholtz resonance chamber is formed between the tuning cloth, and through hole of the washer and the inner surface of the faceplate.

20. The microphone module of claim 19, further comprising a top cover defining a receiving hole therein, engaged with the bottom cover, and disposed between the bottom cover and the faceplate, wherein the circuit board is positioned between the bottom cover an the top cover, and the microphone is received in the receiving hole of the top cover; the washer is annular-shaped and made of elastic material, and a diameter of the through hole of the washer is larger than that of the sound hole.
